(19) United States
(12) Patent Application Publication
(10) Pub. No.: US 2025/0135357 A1
(43) Pub. Date: May 1, 2025

(54) METHOD AND APPARATUS FOR PROCESSING GROUP JOINING REQUEST

(71) Applicant: Tencent Technology (Shenzhen) Company Limited, Shenzhen (CN)

(72) Inventor: Teng CHEN, Shenzhen (CN)

(73) Assignee: Tencent Technology (Shenzhen) Company Limited, Shenzhen, GD (CN)

(21) Appl. No.: 19/004,074

(22) Filed: Dec. 27, 2024

Related U.S. Application Data
(63) Continuation of application No. PCT/CN2023/116776, filed on Sep. 4, 2023.

(30) Foreign Application Priority Data
Dec. 12, 2022 (CN) 202211597239.2

(51) Int. Cl. A63F 13/795; A63F 13/87

(52) U.S. Cl. CPC A63F 13/795; A63F 13/87

(57) ABSTRACT

In a method for processing requests to join an interactive group, a first virtual character and a first virtual object are displayed in a virtual environment. The first virtual object represents the interactive group, and a first user account manages the interactive group. A first request to join the interactive group is displayed. The first request to join the interactive group is initiated by the first virtual character. When the first request to join the interactive group is accepted, the first virtual object being entered by the first virtual character is displayed. Apparatus and non-transitory computer-readable storage medium counterpart embodiments are also contemplated.

### RELATED APPLICATIONS

The present application is a continuation of International Application No. PCT/CN2023/116776, filed on Sep. 4, 2023, which claims priority to Chinese Patent Application No. 202211597239.2, filed on Dec. 12, 2022. The entire disclosures of the prior applications are hereby incorporated by reference.

### FIELD OF THE TECHNOLOGY

This disclosure relates to the field of virtual world technologies, including to a method and an apparatus for processing a group joining request, a device, and a storage medium.

### BACKGROUND OF THE DISCLOSURE

In an application, a user account often needs to join various groups, such as a learning exchange group and a sports hobby group.

In related art, when a group administrator account receives a group joining request, a terminal on which the group administrator account logs in displays a request window. The request window displays an application reason inputted by a user account in text form, and the group administrator account determines whether to allow the user account to join the group.

However, the foregoing method of group joining and an effect achieved are monotonous.

### SUMMARY

This disclosure provides a method and an apparatus for processing a group joining request, a device, and a storage medium. The technical solutions include the following:

According to an aspect of this disclosure, a method for processing requests to join an interactive group is provided. In the method, a first virtual character and a first virtual object are displayed in a virtual environment. The first virtual object represents the interactive group, and a first user account manages the interactive group. A first request to join the interactive group is displayed. The first request to join the interactive group is initiated by the first virtual character. When the first request to join the interactive group is accepted, the first virtual object being entered by the first virtual character is displayed.

According to an aspect of this disclosure, an information processing apparatus is provided. The apparatus includes processing circuitry that is configured to display a first virtual character and a first virtual object in a virtual environment, the first virtual object representing an interactive group, and a first user account managing the interactive group. The processing circuitry is configured to display a first request to join the interactive group, the first request to join the interactive group being initiated by the first virtual character. The processing circuitry is configured to display, when the first request to join the interactive group is accepted, the first virtual object being entered by the first virtual character.

According to an aspect of this disclosure, a computer device is provided. The computer device includes a processor and a memory. The memory has at least one instruction, at least one program, a code set, or an instruction set stored therein, and the at least one instruction, the at least one program, the code set, or the instruction set is loaded and executed by the processor to implement the method for processing a group joining request according to any one of the foregoing aspects.

According to an aspect of this disclosure, a non-transitory computer-readable storage medium is provided. The non-transitory computer-readable storage medium has at least one instruction, at least one program, a code set, or an instruction set stored thereon, and the at least one instruction, the at least one program, the code set, or the instruction set is loaded and executed by a processor to implement the method for processing a group joining request according to any one of the foregoing aspects.

According to an aspect of this disclosure, a computer program product is provided. The computer program product includes computer instructions. The computer instructions are stored in a computer-readable storage medium, and a processor reads the computer instructions from the computer-readable storage medium and executes the computer instructions to implement the method for processing a group joining request according to any one of the foregoing aspects.

Technical solutions provided in this disclosure have at least the following beneficial effects.

The interactive group is displayed as the virtual building in the virtual environment, and the first account having the management permission of the interactive group directly processes the group joining request initiated by the first virtual object in the virtual environment, thereby diversifying the method for processing the group joining request in the virtual environment. A process of processing the group joining request is simplified by directly agreeing to the group joining request in the virtual environment. The group joining request is converted into an active behavior of the virtual object in the virtual environment, to promote the virtual object to perform an interaction behavior in the virtual environment, improve immersive experience in the virtual environment, and improve efficiency of human computer interaction without a need to open a receiving page for the group joining request and process the group joining request on the receiving page.

In addition, “request group joining-process the group joining-complete the group joining” is presented through a dynamic virtual scene to prevent the group administrator from handling the group joining request in a stiff and mechanical manner. A dynamic visual effect is conducive to improving group administrator's immersive experience and processing enthusiasm, thereby improving efficiency of the group administrator in handling the group joining request and improving efficiency of human-computer interaction.

### BRIEF DESCRIPTION OF THE DRAWINGS

FIG. 1 is a block diagram of a structure of a computer system according to an example of this disclosure.

FIG. 2 is a schematic diagram of a virtual environment according to an example of this disclosure.

FIG. 3 is a flowchart of a method for processing a group joining request according to an example of this disclosure.

FIG. 4 is a flowchart of a method for processing a group joining request according to an example of this disclosure.

FIG. 5 is a schematic diagram of a processing interface according to an example of this disclosure.

FIG. 6 is a flowchart of a method for processing a group joining request according to an example of this disclosure.

FIG. 7 is a flowchart of a method for processing a group joining request according to an example of this disclosure.

FIG. 8 is a flowchart of a method for processing a group joining request according to an example of this disclosure.

FIG. 9 is a flowchart of a method for processing a group joining request according to an example of this disclosure.

FIG. 10 is a flowchart of a method for processing a group joining request according to an example of this disclosure.

FIG. 11 is a schematic diagram of an identity information interface according to an example of this disclosure.

FIG. 12 is a flowchart of a method for processing a group joining request according to an example of this disclosure.

FIG. 13 is a flowchart of a method for processing a group joining request according to an example of this disclosure.

FIG. 14 is a flowchart of a method for processing a group joining request according to an example of this disclosure.

FIG. 15 is a flowchart of a method for processing a group joining request according to an example of this disclosure.

FIG. 16 is a flowchart of a method for processing a group joining request according to an example of this disclosure.

FIG. 17 is a block diagram of an apparatus for processing a group joining request according to an example of this disclosure.

FIG. 18 is a block diagram of a structure of a computer device according to an example of this disclosure.

### DETAILED DESCRIPTION

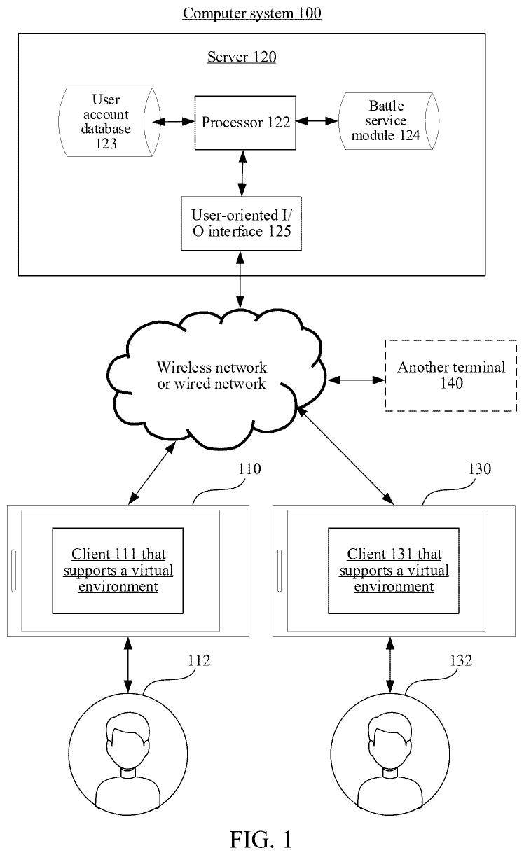

FIG. 1 is a block diagram of a structure of a computer system according to an example of this disclosure. The computer system 100 includes: a first terminal 110, a server 120, and a second terminal 130.

A client 111 that supports a virtual environment is installed and run on the first terminal 110. The client 111 may be a social application, a multiplayer online battle program, or the like. When the first terminal runs the client 111, a user interface of the client 111 is displayed on a screen of the first terminal 110. The client 111 may be any one of a battle royale shooting game, a virtual reality (VR) application, an augmented reality (AR) program, a three-dimensional map program, a virtual reality game, an augmented reality game, a first-person shooting game (FPS), a third-personal shooting game (TPS), a multiplayer online battle arena game (MOBA), or a simulation game (SLG). In an embodiment, an example in which the client 111 is a FPS game is used for description. The first terminal 110 is a terminal used by a first user 112. The first user 112 uses the first terminal 110 to control a first virtual object in the virtual environment to carry out an activity. The first virtual object may be referred to as a virtual object of the first user 112. An activity of the first virtual object includes but is not limited to: at least one of moving, jumping, teleporting, casting a skill, using an item, adjusting a body posture, crawling, walking, running, riding, flying, driving, picking up, shooting, attacking, or throwing. For example, the first virtual object is a virtual character, such as a simulation character or an animation character.

A client 131 that supports a virtual environment is installed and run on the second terminal 130. The client 131 may be a multiplayer online battle program. When the second terminal 130 runs the client 131, a user interface of the client 131 is displayed on a screen of the second terminal 130. The client may be any one of a battle royale shooting game, a VR application, an AR program, a three-dimensional map program, a virtual reality game, an augmented reality game, an FPS, a TPS, a MOBA, or an SLG. In one embodiment, an example in which the client is a MOBA game is used for description. The second terminal 130 is a terminal used by a second user 132. The second user 132 uses the second terminal 130 to control a second virtual object in the virtual environment to carry out an activity. The second virtual object may be referred to as a virtual object of the second user 132. For example, the second virtual object is a virtual character, such as a simulation character or an animation character.

In one embodiment, the first virtual object and the second virtual object are in the same virtual environment. In one embodiment, the first virtual object and the second virtual object may belong to the same camp, the same team, the same organization, have a friend relationship, or have temporary communication permission. In one embodiment, the first virtual object and the second virtual object may belong to different camps, different teams, different organizations, or have an adversarial relationship.

In one embodiment, the clients installed on the first terminal 110 and the second terminal 130 are the same, or the clients installed on the two terminals are clients of the same type on different operating system platforms (Android or IOS). The first terminal 110 may generally be one of a plurality of terminals, and the second terminal 130 may generally be another one of the plurality of terminals. In this embodiment, only the first terminal 110 and the second terminal 130 are used as examples. Device types of the first terminal 110 and the second terminal 130 are the same or different. The device type includes: at least one of a smart phone, a tablet, an e-book reader, a Moving Picture Experts Group Audio Layer III (MP3) player, a Moving Picture Experts Group Audio Layer IV (MP4) player, a portable laptop computer, and a desktop computer. The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

FIG. 1 only shows two terminals. However, there are a plurality of terminals 140 that can access the server 120 in different embodiments. In one embodiment, there are alternatively one or more terminals 140 that correspond to a developer. A development and editing platform for a client that supports a virtual environment is installed on the terminal 140. The developer may edit and update the client on the terminal 140, and transmit an updated client installation package to the server 120 over a wired or wireless network. The first terminal 110 and the second terminal 130 may download the client installation package from the server 120 to update the client.

The first terminal 110, the second terminal 130, and another terminal 140 are connected to the server 120 over a wireless network or a wired network.

The server 120 includes at least one of a server, a plurality of servers, a cloud computing platform, and a virtualization center. The server 120 is configured to provide a background service for a client that supports a three-dimensional virtual environment. In one embodiment, the server 120 is response for primary computing work, and the terminals are response for secondary computing work. Alternatively, the server 120 is response for secondary computing work, and the terminals are response for primary computing work. Alternatively, a distributed computing architecture may be used between the server 120 and the terminals for collaborative computing.

For example, the server 120 includes a processor 122, a user account database 123, a battle service module 124, and a user-oriented input/output interface (I/O interface) 125. The processor 122 is configured to load instructions stored in the server 121 and process data in the user account database 123 and the battle service module 124. The user account database 123 is configured to store data of user accounts used in the first terminal 110, the second terminal 130, and another terminal 140, for example, avatars of the user accounts, nicknames of the user accounts, combat effectiveness indexes of the user accounts, and service zones of the user accounts. The battle service module 124 is configured to provide a plurality of battle rooms for users to battle, for example, 1V1 battle, 3V3 battle, and 5V5 battle. The user-oriented I/O interface 125 is configured to establish communication with the first terminal 110 and/or the second terminal 130 over a wireless network or a wired network for data exchange.

The method provided in this disclosure may be applied to at least one of the following scenarios, but is not limited to: a social application, a virtual reality application, a three-dimensional map application, a first-person shooting game (FPS), a third-person shooting game (TPS), a multiplayer online battle arena game (MOBA), a multiplayer gun battle survival game, and the like.

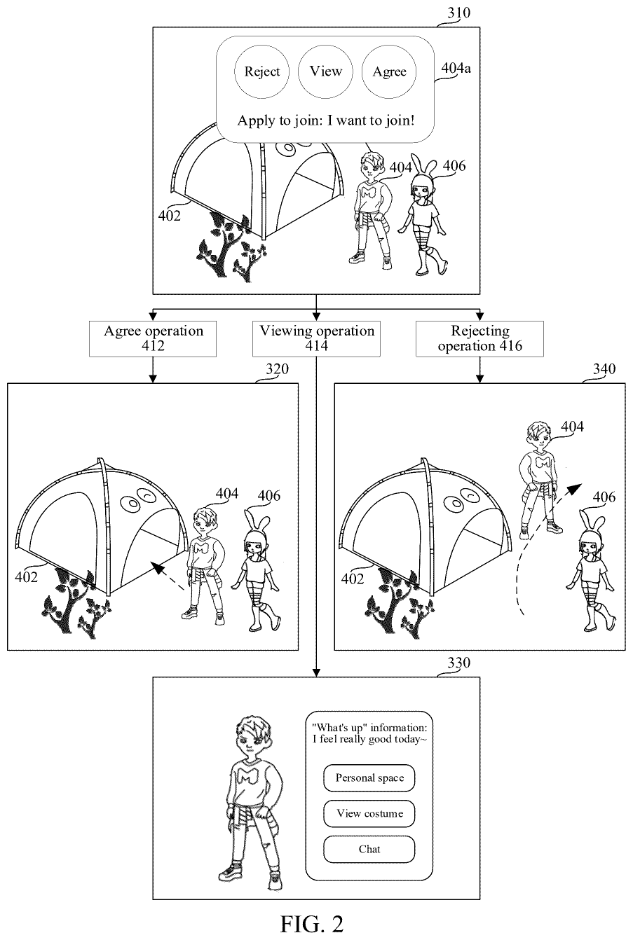

FIG. 2 is a schematic diagram of a virtual environment according to an embodiment of this disclosure.

A virtual building 402 is displayed on a first interface 310. The virtual building 402 corresponds to an interactive group. The virtual building 402 is specifically displayed as a virtual tent. A first virtual object 404 approaches the virtual building 402 to initiate a group joining request to join the interactive group, and a processing interface 404a for the group joining request is displayed. The processing interface 404a for the group joining request includes an agree control, a viewing control, and a rejection control.

A second virtual object 406 is also displayed on the first interface 310. A moment at which the second virtual object 406 initiates a group joining request to join the interactive group is later than a moment at which the first virtual object 404 initiates the group joining request to join the interactive group. The second virtual object 406 is located behind the first virtual object 404.

A second interface 320 is displayed in response to an agree operation 412. The agree operation 412 is tapping/clicking the agree control in the processing interface 404a for the group joining request. In the second interface 320, the first virtual object 404 is agreed to join the interactive group. That the first virtual object 404 enters the virtual tent is displayed. After the first virtual object 404 enters the virtual tent, the second virtual object 406 moves forward to a historical/previous location at which the first virtual object 404 stands when the first virtual object initiates the group joining request.

A third interface 330 is displayed in response to a viewing operation 414. The viewing operation 414 is tapping/clicking the viewing control in the processing interface 404a for the group joining request. In the third interface 330, identity information of the first virtual object 404 is displayed.

A fourth interface 340 is displayed in response to a rejecting operation 416. The rejecting operation 416 is tapping/clicking the rejection control in the processing interface 404a for the group joining request. In the fourth interface 340, the first virtual object 404 is rejected from joining the interactive group. That the first virtual object 404 leaves the virtual tent is displayed. After the first virtual object 404 leaves away from the virtual tent, the second virtual object 406 moves forward to a historical location at which the first virtual object 404 stands when the first virtual object initiates the group joining request.

Next, a method for processing a group joining request is described through the following embodiments.

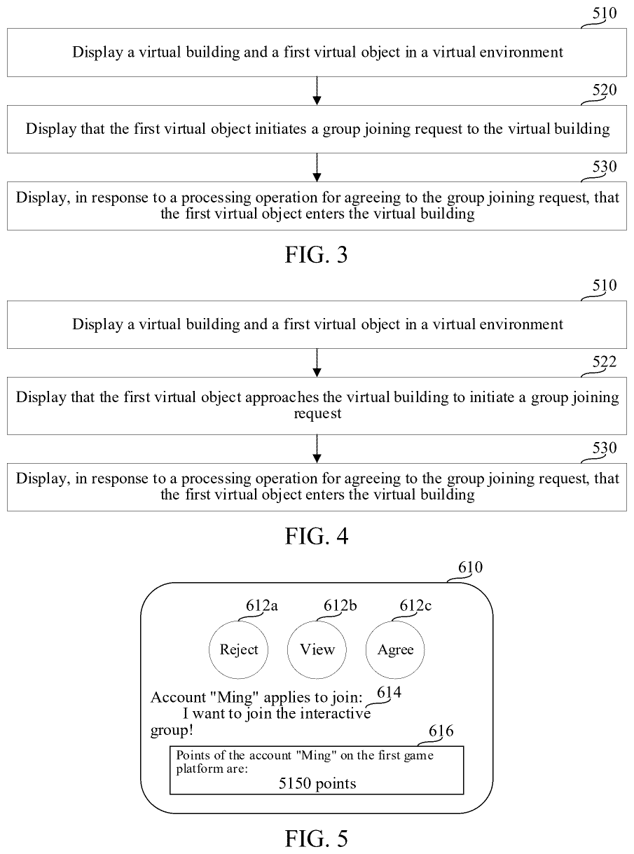

FIG. 3 is a flowchart of a method for processing a group joining request according to an example of this disclosure. The method is described by using an example in which the method is performed by a terminal. The method includes the following operations.

Operation 510: Display a virtual building and a first virtual object in a virtual environment.

For example, the terminal performing this embodiment is logged in with a first account. The first account is an account belonging to a platform where an interactive group is located.

For example, a virtual building is a building representing the interactive group in a virtual environment, the interactive group is configured for hosting at least two group members to interact, and the first account has management permission of the interactive group. For example, the virtual environment may host one or more virtual buildings, and one or more virtual objects. An account that controls a virtual object in the virtual environment and an account that has management permission of the virtual building usually belong to the same platform, but it is not ruled out that the accounts belong to different platforms. For example, the platform includes but is not limited to at least one of a social platform, a payment platform, a game platform, or an audio and video platform.

In one embodiment, the virtual building includes a virtual tent, a virtual room, a virtual space station, a virtual mansion, and the like. The virtual building is configured to accommodate a member in the interactive group. In one embodiment, the virtual building is to be displayed on an interface, and a shadow of the member in the interactive group is displayed on appearance of the virtual building. Specifically, a shadow of a member virtual object is projected on the appearance of the virtual building through an internal light source of the virtual building, and the member virtual object is a virtual object corresponding to a member account that has joined the interactive group.

For example, the first account has the management permission of the interactive group, and the first account is not an account controlling the first virtual object. In an example, the first account controls a main control virtual object, and the main control virtual object is usually a group member in the interactive group corresponding to the virtual building.

Operation 520: Display that the first virtual object initiates the group joining request to the virtual building.

The group joining request refers to a request to join an interactive group. The group joining request is to be sent to an administrator account of the interactive group. If the administrator account agrees to the request, a user account initiating the request becomes a member account of the interactive group.

For example, the first virtual object initiates the group joining request to the virtual building, and applies to become a group member in the interactive group by using the group joining request.

For example, the first virtual object may approach or touch the virtual building to directly initiate the group joining request, or may send a virtual medium to the virtual building to indirectly initiate the group joining request, for example, sending an application letter to the virtual building. The method of initiating the group joining request is not limited in this embodiment.

Operation 530: Display, in response to a processing operation for agreeing to the group joining request, that the first virtual object enters the virtual building.

For example, it indicates that the group joining request initiated by the first virtual object is agreed to in response to the processing operation that is for agreeing to the group joining request and that is on the terminal on which the first account is logged in, and an account corresponding to the first virtual object becomes a group member in the interactive group. Displaying that the first virtual object enters the virtual building indicates that the group joining request initiated by the first virtual object is agreed.

In conclusion, according to the method provided in this embodiment, the interactive group is displayed as the virtual building in the virtual environment, and the first account having the management permission of the interactive group directly processes the group joining request initiated by the first virtual object in the virtual environment, thereby diversifying the method for processing the group joining request in the virtual environment. A process of processing the group joining request is simplified by directly agreeing to the group joining request in the virtual environment. The group joining request is converted into an active behavior of the virtual object in the virtual environment, to promote the virtual object to perform an interaction behavior in the virtual environment, improve immersive experience in the virtual environment, and improve efficiency of human-computer interaction without a need to open a receiving page for the group joining request and process the group joining request on the receiving page.

FIG. 4 is a flowchart of a method for processing a group joining request according to an example of this disclosure. The method is described by using an example in which the method is performed by a terminal. In other words, operation 520 in the embodiment shown in FIG. 3 may be implemented as operation 522.

Operation 522: Display that the first virtual object approaches the virtual building to initiate the group joining request.

Approaching means that the first virtual object moves toward the virtual building. Specifically, approaching means a process in which a distance between the first virtual object and the virtual building is continuously reduced. In one embodiment, when the first virtual object moves toward the virtual building and reaches a specified location, that the first virtual object initiates the group joining request is displayed.

For example, that the first virtual object approaches the virtual building indicates that the first virtual object initiates the group joining request. For example, that the first virtual object waits at an entrance of the virtual building indicates that the first virtual object initiates the group joining request.

For example, after the first virtual object approaches the virtual building, a processing interface for the group joining request is displayed. The processing interface for the group joining request is configured for providing an operation entry for the processing operation for agreeing to the group joining request. In an example, an agree control is provided on the processing interface, and the processing operation for agreeing to the group joining request is triggering the agree control.

In one embodiment, an operation entry of another processing operation, such as a processing operation for viewing the group joining request, a processing operation for rejecting the group joining request, or a processing operation for putting the group joining request on hold, is provided on the processing interface. Further, the processing interface further includes an application reason why the first virtual object initiates the group joining request.

In an example, a display mode of the processing interface for the group joining request includes at least one of the following: displaying in a pop-up window; displaying in a bubble; displaying in a banner notification; displaying in a pop-up message card; and displaying based on the first virtual object.

In this embodiment of this disclosure, that first virtual object approaches the virtual building to initiate, to the virtual building, the group joining request in the form of a bubble above the head of the first virtual object is displayed. In one embodiment, when the first virtual object reaches the specified location, a bubble message is to be displayed above the head of the first virtual object, and the bubble message carries the group joining request.

In one embodiment, the group joining request includes a request reason inputted by a second account corresponding to the first virtual object, to simulate the first virtual object initiating a dialog with the virtual building. Indicatively, the request reason is “I hope to communicate about basketball with more friends.” The second account is an account corresponding to the first virtual object on a platform where the interactive group is located.

FIG. 5 is a schematic diagram of a processing interface according to an example of this disclosure. In this figure, a processing interface 610 is displayed in a bubble. The processing interface 610 includes a rejection control 612a, a viewing control 612b, and an agree control 612c.

For example, the processing operation for agreeing to the group joining request is implemented as triggering the agree control 612c; the processing operation for rejecting the group joining request is implemented as triggering the rejection control 612a; and the processing operation for viewing the group joining request is implemented as triggering the viewing control 612b.

The processing interface 610 further includes application information 614. The application information 614 is configured for indicating the application reason why the first virtual object requests to join the interactive group.

The processing interface 610 further includes extended information 616 of the first virtual object. The extended information 616 may be specifically implemented as interest information and/or association information of the first virtual object. For descriptions of the interest information and the association information, refer to operation 526 and operation 528 below. This is not described herein again.

According to the method provided in this embodiment, the interactive group is displayed as the virtual building in the virtual environment, the first virtual object approaches the virtual building to initiate the group joining request, and the first account having management permission of the interactive group directly processes the group joining request in the virtual environment, thereby diversifying the method for processing the group joining request in the virtual environment. A process of processing the group joining request is simplified by directly agreeing to the group joining request in the virtual environment. Immersive experience in the virtual environment is improved, and efficiency of human-computer interaction is improved without a need to separately design sending and receiving pages for the group joining request.

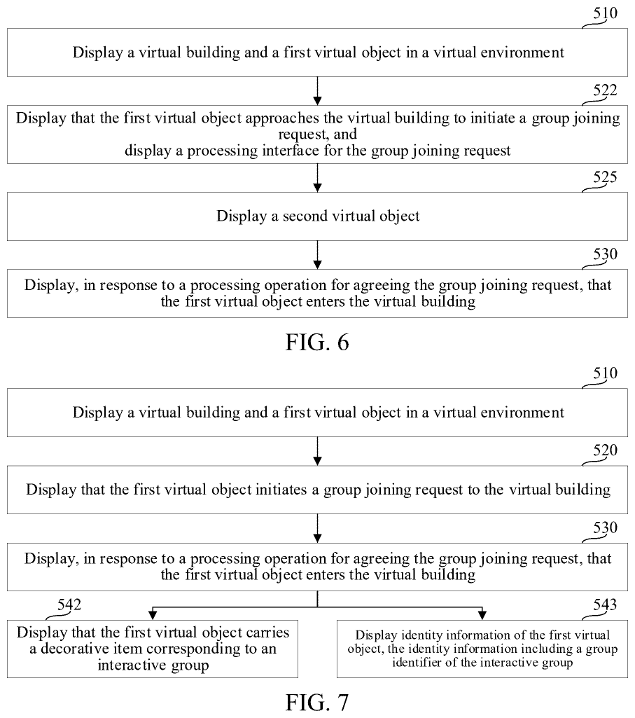

FIG. 6 is a flowchart of a method for processing a group joining request according to an example of this disclosure. The method is described by using an example in which the method is performed by a terminal. In other words, based on the embodiment shown in FIG. 4, the method further includes operation 525.

Operation 525: Display a second virtual object.

The second virtual object refers to another virtual object other than the first virtual object that applies to join the group, and the second virtual object is located behind the first virtual object in a waiting queue. A moment at which an account corresponding to the second virtual object initiates applying to join the group is later than a moment at which an account corresponding to the first virtual object initiates applying to join the group.

For example, the second virtual object and the first virtual object form the waiting queue. The second virtual object is located behind the first virtual object in the waiting queue. Specifically, the second virtual object faces the back of the first virtual object, or a distance between the second virtual object and a virtual building is greater than a distance between the first virtual object and the virtual building.

In one embodiment, a moment at which the second virtual object initiates the group joining request to the virtual building is later than a moment at which the first virtual object initiates the group joining request to the virtual building. For example, a corresponding second timestamp at which the second virtual object initiates the group joining request to the virtual building is later than a corresponding first timestamp at which the first virtual object initiates the group joining request to the virtual building.

In one embodiment, a processing interface for the group joining request of the first virtual object is displayed, to preferentially process the group joining request initiated by the first virtual object at the earlier timestamp corresponding to the group joining request. Further, the processing interface for the group joining request is switched, by triggering the second virtual object, to a processing interface corresponding to the second virtual object.

In an example of this embodiment, after operation 530 of this embodiment, the following operations are further included.

That second virtual object moves to a historical location of the first virtual object is displayed.

For example, after operation 530, the first virtual object enters the virtual building, and the second virtual object moves to the historical location of the first virtual object. The historical location is a location of the first virtual object when the first virtual object initiates the group joining request.

For example, after the first virtual object enters the virtual building, a location of the second virtual object is adjusted, and a location of a virtual object in the waiting queue is updated to facilitate observation of a situation in the waiting queue.

In one embodiment of this disclosure, that the second virtual object initiates the group joining request to the virtual building is displayed. That the second virtual object enters the virtual building is displayed in response to a processing operation for agreeing to the group joining request.

In another embodiment of this disclosure, that the second virtual object initiates the group joining request to the virtual building is displayed. Identity information of the second virtual object is displayed in response to a processing operation for viewing the group joining request, the identity information of the second virtual object including identity information of the account corresponding to the second virtual object.

In another embodiment of this disclosure, that the second virtual object initiates the group joining request to the virtual building is displayed. That the second virtual object moves to be away from the virtual building is displayed in response to a processing operation for rejecting the group joining request.

In another embodiment of this disclosure, that the second virtual object steps aside is displayed in response to a processing operation for putting the group joining request on hold, to enable a next virtual object to initiate the group joining request.

In conclusion, according to the method provided in this embodiment, the interactive group is displayed as the virtual building in the virtual environment, that the second virtual object and the first virtual object initiating the group joining requests form a waiting queue is displayed, and a first account having management permission of the interactive group directly processes the group joining request in the virtual environment, thereby diversifying the method for processing the group joining request in the virtual environment. A process of processing the group joining request is simplified by directly agreeing to the group joining request in the virtual environment, to provide a solution for a plurality of virtual objects to initiate group joining requests. Immersive experience in the virtual environment is improved, and efficiency of human-computer interaction is improved without a need to separately design sending and receiving pages for the group joining request.

Next, a display method after the first virtual object enters the virtual building is described:

FIG. 7 is a flowchart of a method for processing a group joining request according to an example of this disclosure. The method is described by using an example in which the method is performed by a terminal. In other words, based on the embodiment shown in FIG. 3, the method further includes operation 542 and operation 543.

Operation 542: Display that the first virtual object carries a decorative item corresponding to the interactive group.

For example, the decorative item carried by the first virtual object includes but is not limited to at least one of clothing, jewelry, a hat, shoes, a backpack, a badge, special effects animation, a vehicle, or the like. In one embodiment, the decorative item corresponding to the interactive group is preset, the decorative item and the virtual building have the same appearance feature, and the appearance feature includes but is not limited to at least one of a pattern, a color, a material, or the like.

For example, the first virtual object may automatically carry the decorative item after entering the virtual building, or permission of carrying the decorative item may be activated after the first virtual object enters the virtual building. An example in which the decorative item is a virtual necklace is used, after entering the virtual building, the first virtual object may directly wear the virtual necklace, or obtain the virtual necklace from owned items, which is determined by the first virtual object whether to wear the virtual necklace. Alternatively, the first virtual object may obtain permission of purchasing the virtual necklace, which is determined by the first virtual object whether to purchase the virtual necklace.

Operation 543: Display identity information of the first virtual object, the identity information including a group identifier of the interactive group.

For example, the identity information of the first virtual object may be automatically displayed after the first virtual object enters the virtual building, or may be displayed in response to a triggering operation on the identity information. When the identity information of the first virtual object is automatically displayed, or is displayed in responding to the triggering operation on the identity information for the first time, animation of obtaining the group identifier is displayed.

For example, the group identifier may be specifically implemented as at least one of a virtual tag, a virtual badge, or a virtual monument. For example, the virtual tag is displayed around account information of the first virtual object, the virtual badge is displayed in a badge wall of the first virtual object, and the virtual monument is placed in personal space of the first virtual object. Further, an identity information page carries the identity information of the first virtual object, and the identity information page also carries a function entry of the badge wall and/or a function entry of the personal space. For example, the personal space is a personal area corresponding to the first virtual object in the virtual environment, such as at least one of a virtual nest, a virtual house, or the like.

Operation 541 and operation 542 of this embodiment may be split and combined with other operations of this embodiment to form a new embodiment to be implemented separately, which is not limited in this disclosure.

In conclusion, according to the method provided in this embodiment, by displaying the decorative item or an identity identifier after the first virtual object enters the virtual building, information about the interactive group to which the first virtual object joins in the virtual environment is observed. A group member in the interactive group may directly observe a virtual object belonging to the same interactive group in the virtual environment and form a team to carry out a virtual activity, promoting interaction frequency between virtual objects in the virtual environment, and improving interaction efficiency without a need of mutual confirmation of identity information through chatting.

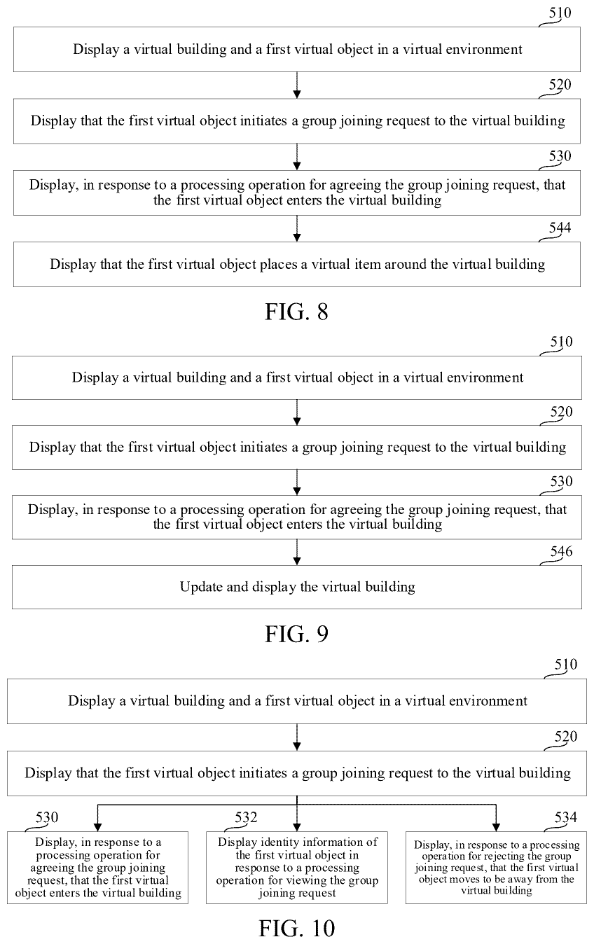

FIG. 8 is a flowchart of a method for processing a group joining request according to an example of this disclosure. The method is described by using an example in which the method is performed by a terminal. In other words, based on the embodiment shown in FIG. 3, the method further includes operation 544.

Operation 544: Display that the first virtual object places the virtual item around the virtual building.

For example, the first virtual object carries a virtual item, and the virtual item is an item provided to the interactive group when the first virtual object requests to join the interactive group. In one embodiment, the virtual item refers to an item configured to decorate the virtual building, such as a virtual tree, a virtual flower, a virtual vase, and a virtual picture frame. In an example, the first virtual object initiates the group joining request to the interactive group by carrying the virtual item.

In one implementation, the virtual item is a virtual ticket. That the first virtual object carries the virtual ticket indicates that the first virtual object initiates the group joining request. After the first virtual object enters the virtual building, the virtual ticket is converted into a virtual ornament, such as at least one of a tree, a flower, a vase, or a picture frame. The virtual ornament is placed around the virtual building.

In another implementation, the virtual item is a virtual ornament. The first virtual object carries the virtual ornament and temporarily transfers ownership of the virtual ornament to the interactive group when initiating the group joining request. After the first virtual object enters the virtual building, the interactive group obtains long-term ownership of the virtual ornament and that the virtual ornament is placed around the virtual building is displayed. In one embodiment, when the group joining request of the first virtual object is rejected, the ownership of the virtual ornament is returned to the first virtual object.

In conclusion, according to the method provided in this embodiment, the virtual item is placed around the virtual building, to add, after the first virtual object enters the virtual building, the virtual item to decorate the virtual building. The virtual object in the virtual environment may understand, by observing the virtual item, a basic situation of the interactive group, such as a quantity of group members, without a need to view group information, thereby improving efficiency of human-computer interaction.

FIG. 9 is a flowchart of a method for processing a group joining request according to an example of this disclosure. The method is described by using an example in which the method is performed by a terminal. In other words, based on the embodiment shown in FIG. 3, the method further includes operation 546.

Operation 546: Update and display the virtual building.

For example, after the first virtual object enters the virtual building, the group member in the interactive group changes, and the virtual building of the interactive group is updated and displayed (e.g., refreshed).

In an example, a volume of the virtual building is positively correlated with a quantity of members in the interactive group. To be specific, after the first virtual object enters the virtual building, the quantity of group members in the interactive group increases, and the volume of the virtual building increases.

In another example, when the quantity of members in the interactive group reaches a stage threshold, the virtual building is replaced. For example, when there are five interactive group members, an original virtual tent is replaced with a virtual room. When there are 20 interactive group members, the original virtual room is replaced with a virtual mansion. When there are 100 interactive group members, the original virtual mansion is replaced with a virtual castle.

In another implementation, relevant information of the first virtual object is displayed on the virtual building. For example, the first virtual object is indirectly displayed on the virtual building. The virtual building is implemented as a virtual castle, and at least one avatar, a nickname, and an identity identifier of the first virtual object is displayed on an outer wall of the virtual castle. The first virtual object is directly displayed on the virtual building. The virtual building is implemented as a virtual block, and that the first virtual object performs a virtual activity in the virtual block is displayed. A specific manner of displaying the first virtual object on the virtual building is not limited in this embodiment.

In an example, the relevant information of the first virtual object displayed on the virtual building is a virtual identity identifier, that is, a virtual identity identifier corresponding to virtual identity of the first virtual object is displayed on the virtual building. For example, the virtual identity of the first virtual object is a craftsman, and the virtual identity identifier displayed on the virtual building is a hammer logo. Not only the virtual identity identifier corresponding to the virtual identity corresponding to the first virtual object is displayed on the virtual building, but also a virtual identity identifier corresponding to virtual identity of another group member in the interactive group may be displayed.

Further, a display style of the virtual identity identifier is related to a quantity of members in the interactive group having the virtual identity corresponding to the virtual identity identifier, and the display style includes but is not limited to at least one of a size, a color, a material, a pattern, or texture. An example in which the virtual identity is a craftsman is used. When a quantity of group members whose virtual identity is craftsmen does not exceed a first quantity threshold, a size of the hammer logo is 200*200 pixels, and a material of the hammer is wood. When a quantity of group members whose virtual identity is the craftsmen exceeds a first quantity threshold but does not exceed a second quantity threshold, a size of the hammer logo is 300*300 pixels, a material of the hammer is metal, and a color of the hammer is silver. When a quantity of group members whose virtual identity is the craftsmen exceeds a second quantity threshold, a size of the hammer logo is 350*350 pixels, a material of the hammer is metal, a color of the hammer is gold, and a wheat car pattern is displayed around the hammer.

The two implementation methods in this embodiment may be implemented separately or simultaneously, which is not limited in this disclosure.

In conclusion, according to the method provided in this embodiment, the virtual building is updated and displayed after the first virtual object enters the virtual building. The virtual object in the virtual environment may understand, by continuously observing the virtual building, a changing trend of the group member in the interactive group, without a need to frequently view group information, thereby improving efficiency of human-computer interaction.

Next, a processing operation for the group joining request is described.

FIG. 10 is a flowchart of a method for processing a group joining request according to an example of this disclosure. The method is described by using an example in which the method is performed by a terminal. In other words, based on the embodiment shown in FIG. 3, the method further includes operation 532 and operation 534.

Operation 532: Display identity information of the first virtual object in response to a processing operation for viewing the group joining request.

For example, the processing operation for the group joining request in this disclosure further includes: at least one of a processing operation for viewing the group joining request, or a processing operation for rejecting the group joining request.

For example, the processing operation for viewing the group joining request may be implemented as triggering a viewing function entry provided in a processing interface for the group joining request.

For example, the identity information of the first virtual object includes identity information of the second account corresponding to the first virtual object. The second account and the first account usually belong to the same platform, but it is not ruled out that the accounts belong to different platforms.

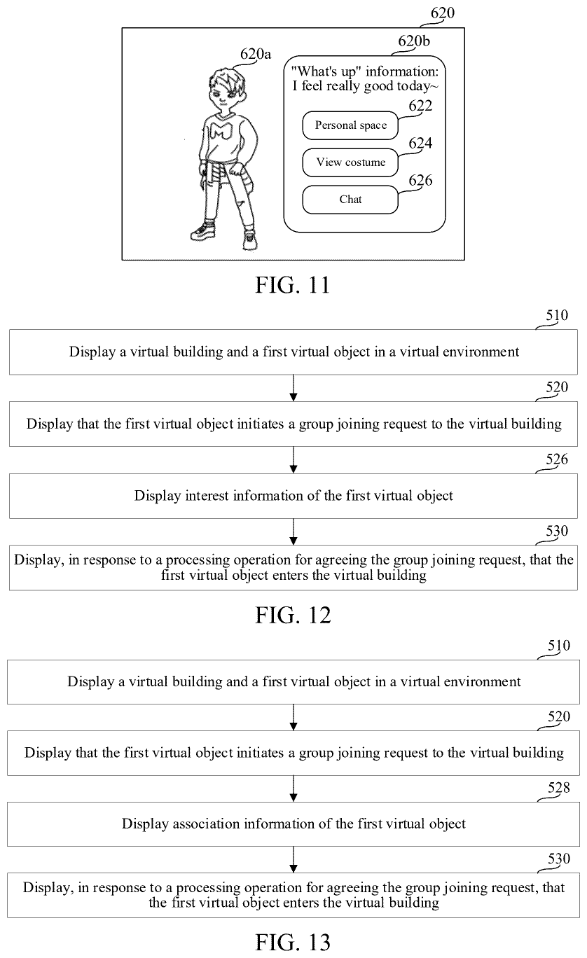

FIG. 11 is a schematic diagram of an identity information interface according to an example of this disclosure.

A first virtual object 620a and an information card 620b are displayed on an identity information interface 620. The information card 620b includes basic identity information of the first virtual object, such as “what's up” information. The information card 620b further includes a Personal space control 622, a View costume control 624, and a Chat control 626, which respectively serve as a personal space function entry for the first virtual object, a function entry for viewing a costume image of the first virtual object, and a chat interaction function entry for the first virtual object.

This embodiment only provides one implementation method of displaying the basic identity information and providing the function entry by using the information card 620b. In another implementation, the identity information interface may provide identity information, or provide a function entry. This embodiment does not constitute a limitation on the identity information interface, and all interfaces presenting the identity information of the first virtual object may be referred to as identity information interfaces.

Operation 534: Display, in response to a processing operation for rejecting the group joining request, that the first virtual object moves to be away from the virtual building.

For example, the processing operation for rejecting the group joining request may be implemented as triggering a rejecting function entry provided in a processing interface for the group joining request.

For example, displaying that the first virtual object is away from the virtual building indicates that the group joining request of the first virtual object is rejected. After the joining request of the first virtual object is rejected, the foregoing operation that the second virtual object moves to the historical location of the first virtual object may be performed.

Operation 532 and operation 534 of this embodiment may be split and combined with other operations of this embodiment to form a new embodiment to be implemented separately, which is not limited in this disclosure.

In conclusion, according to the method provided in this embodiment, through the processing operation for viewing the group joining request or the processing operation for rejecting the group joining request, the first account having the management permission of the interactive group directly processes the group joining request initiated by the first virtual object in the virtual environment, thereby diversifying the method for rejecting or viewing the group joining request in the virtual environment. A process of processing the group joining request is simplified by directly agreeing to the group joining request in the virtual environment. Immersive experience in the virtual environment is improved, and efficiency of human-computer interaction is improved without a need to open a receiving page for the group joining request and process the group joining request on the receiving page.

FIG. 12 is a flowchart of a method for processing a group joining request according to an example of this disclosure. The method is described by using an example in which the method is performed by a terminal. In other words, based on the embodiment shown in FIG. 3, the method further includes operation 526.

Operation 526: Display interest information of the first virtual object.

For example, the virtual building corresponds to an interest tag, and the interest tag is configured for indicating a social preference of the interactive group and/or a behavior preference of a member in the interactive group.

For example, the social preference of the interactive group is attribute information of the interactive group. The social preference may be obtained based on a group tag, such as at least one of a game group, a shopping group, a classmate group, or a fan group, when the interactive group is created or set up. The social preference may alternatively be determined based on at least one of a communication interaction record, a group member identifier, or the like. For example, if frequency of games in the communication interaction record exceeds a quantity threshold, the social preference of the interactive group is a game preference.

For example, the behavior preference of the member in the interactive group is usually a preference of a group member having management permission, but may also include a preference of a group member without management permission. A behavior preference of the first account is used as an example. The behavior preference may be determined based on behavior information of the first account and/or behavior information of an account having a binding relationship with the first account. The behavior information includes but is not limited to at least one of browsing information, application startup information, or interaction information.

A person skilled in the art may understand that, obtaining of the behavior information is subject to separate consent of an authorized object and complies with the relevant laws, regulations, and standards of the relevant countries and regions. For example, a user is clearly prompted through at least one of a user privacy agreement, a pop-up window prompt, or the like, and the information is obtained after the user's full permission. In one implementation, the user is prompted each time the foregoing information is obtained to obtain the user's separate consent.

In one implementation, during requesting the foregoing information from the user, a purpose of the information is displayed to the user. The foregoing information is not used for a purpose beyond a scope of the user consent, and is not uploaded, stored, or disclosed without the user's full permission.

For example, the interest information, such as at least one of identity information, behavior information, or interaction information, is obtained based on a third account in an interest platform indicated by the interest tag, and the third account has a binding relationship with the second account corresponding to the first virtual object.

An example in which the interest tag of the interactive group is a first game is used. The interest information of the first virtual object is obtained based on the third account in a platform of the first game, and the third account has the binding relationship with the second account corresponding to the first virtual object. For example, when the platform of the first game is logged in, information of the second account is authorized.

In conclusion, according to the method provided in this embodiment, the interest information of the first virtual object is displayed, so that information of the account bound to the first virtual object on the interest platform is displayed in an expanded manner. A connection between the interactive group and the interest platform is established based on the interest tag and the interest information is displayed, to simplify a process of processing the group joining request. Immersive experience in the virtual environment is improved, and efficiency of human-computer interaction is improved without a need of manual verification on the information of the account bound to the first virtual object when the first account switches a platform to the interest platform.

FIG. 13 is a flowchart of a method for processing a group joining request according to an example of this disclosure. The method is described by using an example in which the method is performed by a terminal. In other words, based on the embodiment shown in FIG. 3, the method further includes operation 528.

Operation 528: Display association information of the first virtual object.

For example, the group joining request initiated by the first virtual object carries application information. The application information is configured for indicating an application reason why the first virtual object requests to join the interactive group.

For example, an association platform is a platform indicated by the application information, and the application information usually carries relevant information such as a full name and an abbreviation of the association platform.

For example, the association information is obtained based on a third account in the association platform indicated by the application information, and the third account has a binding relationship with the second account corresponding to the first virtual object.

Specifically, when the second account corresponding to the first virtual object initiates the group joining request during cross-platform social interaction, the application information usually indicates the association platform. For example, after a team is formed to play a game in a game platform, a social relationship with a teammate on a social platform is expected to be established. The teammate has already created an interactive group. When the second account applies to join the interactive group, description of identity is to be made, for example, “Hello, I am player A in the first game.”

Based on the application information, the association information of the first virtual object is identity information of the third account in a first game platform, and the third account has a binding relationship with the second account. The association information of the first virtual object is displayed, so that the first account having the management permission of the interactive group does not need to perform cross-platform verification on the application information after receiving the group joining request, and does not need to open the first game platform and then search for the third account.

In conclusion, according to the method provided in this embodiment, the association information of the first virtual object is displayed, so that information of the account bound to the first virtual object on the association platform is displayed in an expanded manner. A connection between the first virtual object and the association platform is established based on the application information carried in the group joining request initiated by the first virtual object, and the association information is displayed, to simplify a process of processing the group joining request. Immersive experience in the virtual environment is improved, and efficiency of human-computer interaction is improved without a need of manual verification on the information of the account bound to the first virtual object when the first account switches a platform to the association platform.

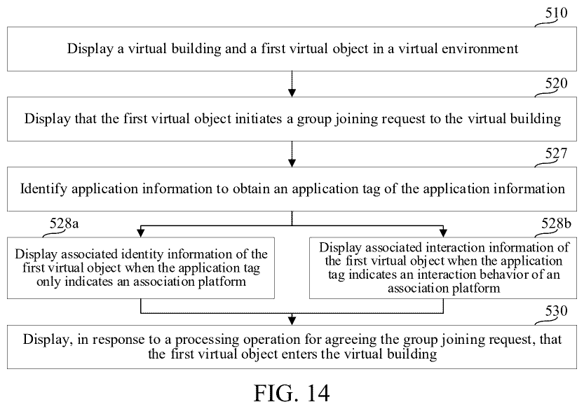

FIG. 14 is a flowchart of a method for processing a group joining request according to an example of this disclosure. The method is described by using an example in which the method is performed by a terminal. In other words, based on the embodiment shown in FIG. 3, the method further includes operation 527, where operation 528 is implemented as operation 528a and operation 528b.

Operation 527: Identify application information to obtain an application tag of the application information.

For example, the application tag is configured for indicating a type of information carried in the application information. In one implementation, the application tag is configured for indicating an association platform in the application information. For example, the application information includes the association platform, but there is no behavior information of the association platform. The application tag is configured for indicating an interaction behavior of the association platform in the application information. For example, the application information includes the association platform, and there is behavior information of the association platform.

Operation 528a: Display associated identity information of the first virtual object when the application tag only indicates the association platform.

For example, when the application tag is a first application tag, association information of the first virtual object is the associated identity information. The associated identity information is identity information of a third account in the association platform. The identity information of the third account is displayed, so that the first account verifies content in the application information.

Operation 528b: Display associated interaction information of the first virtual object when the application tag indicates the interaction behavior of the association platform.

For example, when the application tag is a second application tag, association information of the first virtual object is the associated interaction information. The associated interaction information is interaction information between a third account and a fourth account in the association platform. The associated interaction information of the third account is displayed, so that the first account verifies content in the application information.

Specifically, the first account verifies, based on the associated interaction information, an interaction behavior between the third account and the fourth account carried in the application information. The fourth account has a binding relationship with the interactive group, and/or the fourth account has a binding relationship with the first account.

Specifically, when the second account corresponding to the first virtual object initiates the group joining request during cross-platform social interaction, the application information usually indicates the association platform. For example, after a team is formed to play a game in a game platform, a social relationship with a teammate on a social platform is expected to be established. The teammate has already created an interactive group. When the second account applies to join the interactive group, description of the interaction behavior is to be made, for example, “Hello, I am player A who just form a team in the first game.”

Based on the application information, the association information of the first virtual object is the associated interaction information of the third account in a first game platform, and the third account has a binding relationship with the second account. The associated interaction information of the first virtual object is displayed, and the information of the third account and the fourth account forming the game team is displayed, so that the first account having the management permission of the interactive group does not need to perform cross-platform verification on the application information after receiving the group joining request, and does not need to open the first game platform and then search for the third account.

Operation 528a and operation 528b of this embodiment may be split and combined with other operations of this embodiment to form a new embodiment to be implemented separately, which is not limited in this application.

For example, the associated interaction information includes but is not limited to at least one of the following: information about a like, a comment, forwarding, team forming, visit, chat, subscription, or an intimate relationship between the third account and the fourth account.

In conclusion, according to the method provided in this embodiment, the application information is identified to obtain the application tag of the application information. The associated identity information or associated interaction information of the first virtual object is displayed based on a type of the application tag. A connection between the first virtual object and the association platform is established based on the application information carried in the group joining request initiated by the first virtual object, and the association information is displayed, to simplify a process of processing the group joining request. Immersive experience in the virtual environment is improved, and efficiency of human-computer interaction is improved without a need of manual verification on the information of the account bound to the first virtual object when the first account switches a platform to the association platform.

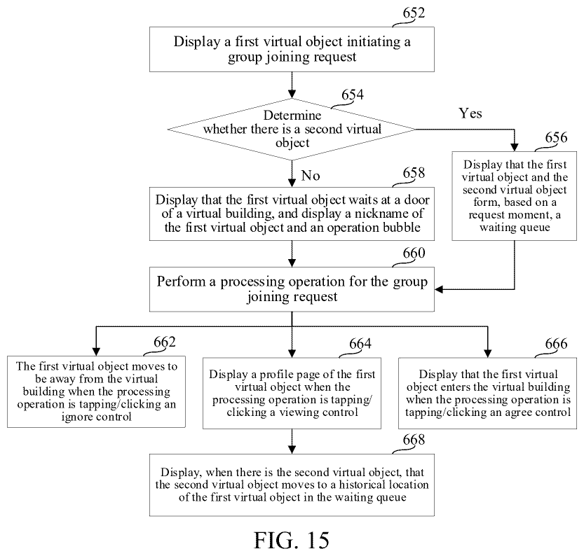

FIG. 15 is a flowchart of a method for processing a group joining request according to an example of this disclosure. The method is described by using an example in which the method is performed by a terminal. The method includes the following operations.

Operation 652: Display a first virtual object initiating a group joining request.

For example, the first virtual object is a character in a virtual environment, and an interactive group corresponding to the group joining request is implemented as a virtual building in the virtual environment.

Operation 654: Determine whether there is a second virtual object.

For example, the second virtual object is another virtual object initiating the group joining request.

Operation 656: Display, when there is the second virtual object, that the first virtual object and the second virtual object form a waiting queue based on a request moment.

For example, the first virtual object is located before the second virtual object in the waiting queue, and an application moment of the first virtual object is earlier than that of the second virtual object.

Operation 658: Display, when there is no second virtual object, that the first virtual object waits at a door of the virtual building, and display a nickname of the first virtual object and an operation bubble.

For example, the virtual building may be specifically implemented as a virtual tent, but is not limited to being implemented as at least one of other implementations such as a virtual mansion, a virtual block, a virtual castle, or the like.

The operation bubble is only one implementation of the processing interface mentioned above, and other implementations are not limited.

Operation 660: Perform a processing operation for the group joining request.

For example, a first account having management permission of the interactive group performs the processing operation.

Operation 662: The first virtual object moves to be away from the virtual building when the processing operation is tapping/clicking an ignore control.

For example, the ignore control is a control provided in the operation bubble, and provides a function entry for an ignore operation.

Operation 664: Display a profile page of the first virtual object when the processing operation is tapping/clicking a viewing control.

For example, the viewing control is a control provided in the operation bubble, and provides a function entry for a viewing operation.

Operation 666: Display that the first virtual object enters the virtual building when the processing operation is tapping/clicking an agree control.

For example, the agree control is a control provided in the operation bubble, and provides a function entry for an agree operation.

Operation 668: Display, when there is the second virtual object, that the second virtual object moves to a historical location of the first virtual object in the waiting queue.

For example, the group joining requests of the first virtual object and the second virtual object are processed in sequence according to an order of the waiting queue.

In conclusion, according to the method provided in this embodiment, the interactive group is displayed as the virtual building in the virtual environment, and the first account having the management permission of the interactive group directly processes the group joining request initiated by the first virtual object in the virtual environment, thereby diversifying the method for processing the group joining request in the virtual environment. A process of processing the group joining request is simplified by directly agreeing to the group joining request in the virtual environment. Immersive experience in the virtual environment is improved, and efficiency of human-computer interaction is improved without a need to open a receiving page for the group joining request and process the group joining request on the receiving page.

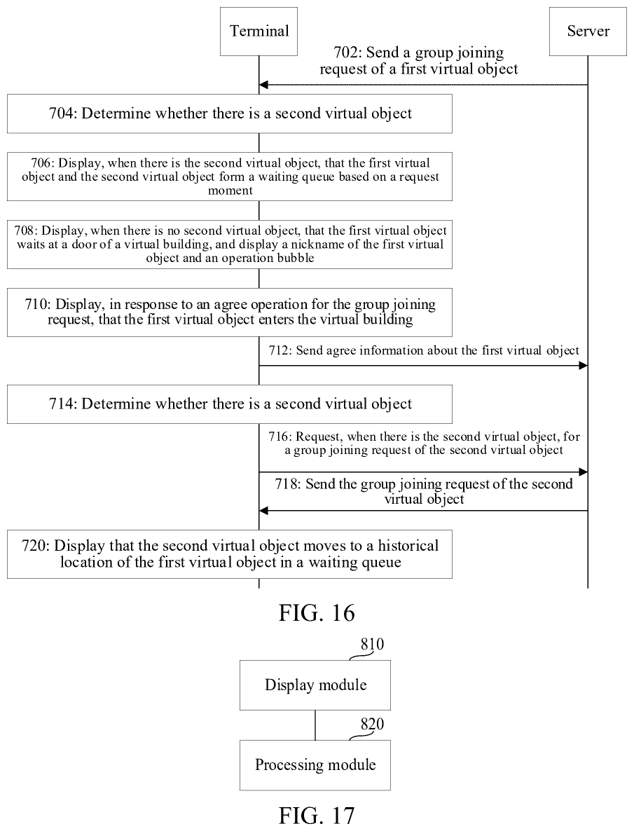

FIG. 16 is a flowchart of a method for processing a group joining request according to an example of this disclosure. The method includes the following operations.

Operation 702: A server sends a group joining request of a first virtual object to a terminal.

For example, the group joining request carries at least one of identity information of the first virtual object, an application reason, or other information.

Operation 704: The terminal determines whether there is a second virtual object.

The terminal determines, based on locations of the second virtual object and a virtual building, whether there is the second virtual object.

Operation 706: The terminal displays, when there is the second virtual object, that the first virtual object and the second virtual object form a waiting queue based on a request moment.

For example, the first virtual object is located before the second virtual object in the waiting queue, and an application moment of the first virtual object is earlier than that of the second virtual object.

Operation 708: The terminal displays, when there is no second virtual object, that the first virtual object waits at a door of the virtual building, and displays a nickname of the first virtual object and an operation bubble.

For example, the virtual building may be specifically implemented as a virtual tent. The operation bubble is only one implementation of the processing interface mentioned above, and other implementations are not limited.

Operation 710: The terminal displays, in response to an agree operation for the group joining request, that the first virtual object enters the virtual building.

For example, an agree control is a control provided in the operation bubble, and provides a function entry for the agree operation.

Operation 712: The terminal sends agree information about the first virtual object to the server.

The terminal notifies the server that the first virtual object is agreed to join the interactive group.

Operation 714: The terminal determines whether there is a second virtual object.

The terminal determines, based on locations of the second virtual object and a virtual building, whether there is the second virtual object.

Operation 716: The terminal requests, when there is the second virtual object, the server for a group joining request of the second virtual object.

Operation 718: The server sends the group joining request of the second virtual object to the terminal.

For example, the group joining request carries at least one of identity information of the second virtual object, an application reason, or other information.

Operation 720: The terminal displays that the second virtual object moves to a historical location of the first virtual object in a waiting queue.

For example, the group joining requests of the first virtual object and the second virtual object are processed in sequence according to an order of the waiting queue.

In conclusion, according to the method provided in this embodiment, the interactive group is displayed as the virtual building in the virtual environment, and the first account having the management permission of the interactive group directly processes the group joining request initiated by the first virtual object in the virtual environment, thereby diversifying the method for processing the group joining request in the virtual environment. A process of processing the group joining request is simplified by directly agreeing to the group joining request in the virtual environment. Immersive experience in the virtual environment is improved, and efficiency of human-computer interaction is improved without a need to open a receiving page for the group joining request and process the group joining request on the receiving page.

A person of ordinary skill in the art may understand that the foregoing embodiments may be implemented independently, or the foregoing embodiments may be freely combined to form a new embodiment to implement the method for processing a group joining request in this disclosure.

FIG. 17 is a block diagram of an apparatus for processing a group joining request according to an example of this disclosure. The apparatus includes:

a display module 810, configured to display a virtual building and a first virtual object in a virtual environment, the virtual building being a building representing an interactive group in the virtual environment, and the first account having management permission of the interactive group.

The display module 810 is further configured to display that the first virtual object initiates the group joining request to the virtual building.

The display module 810 is further configured to display, in response to a processing operation for agreeing to the group joining request, that the first virtual object enters the virtual building.

In an example design of this embodiment, the display module 810 is further configured to:

display that the first virtual object approaches the virtual building to initiate the group joining request.

In an example design of this embodiment, the display module 810 is further configured to:
display a second virtual object, the second virtual object and the first virtual object forming a waiting queue. The second virtual object is located behind the first virtual object in the waiting queue.

A moment at which the second virtual object initiates the group joining request to the virtual building is later than a moment at which the first virtual object initiates the group joining request to the virtual building.

In an example design of this embodiment, the display module 810 is further configured to:
display that the second virtual object moves to a historical location of the first virtual object, the historical location being a location of the first virtual object when the first virtual object initiates the group joining request.

In an example design of this embodiment, the display module 810 is further configured to:
display that the first virtual object approaches the virtual building to initiate, to the virtual building, the group joining request in the form of a bubble above the head of the first virtual object.

In an example design of this embodiment, the group joining request includes a request reason inputted by a second account corresponding to the first virtual object, to simulate the first virtual object initiating a dialog with the virtual building.

In an example design of this embodiment, the display module 810 is further configured to perform at least one of the following:
displaying that the first virtual object carries a decorative item corresponding to the interactive group; or
displaying identity information of the first virtual object, the identity information including a group identifier of the interactive group.

In an example design of this embodiment, the first virtual object carries a virtual item, and the virtual item is an item provided to the interactive group when the first virtual object requests to join the interactive group.

The display module 810 is further configured to:
display that the first virtual object places the virtual item around the virtual building.

In an example design of this embodiment, the display module 810 is further configured to:
update and display the virtual building.

A volume of the virtual building is positively correlated with a quantity of members in the interactive group, and/or relevant information of the first virtual object is displayed on the virtual building.

In an example design of this embodiment, a virtual identity identifier corresponding to virtual identity of the first virtual object is displayed on the virtual building.

A display style of the virtual identity identifier is related to a quantity of members in the interactive group having the virtual identity corresponding to the virtual identity identifier.

In an example design of this embodiment, the display module 810 is further configured to:
display that the second virtual object initiates the group joining request to the virtual building; and display identity information of the first virtual object in response to a processing operation for viewing the group joining request, the identity information of the first virtual object including identity information of the second account corresponding to the first virtual object.

In an example design of this embodiment, the display module 810 is further configured to:
display that the second virtual object initiates the group joining request to the virtual building; and display, in response to a processing operation for rejecting the group joining request, that the first virtual object moves to be away from the virtual building.

In an example design of this embodiment, the display module 810 is further configured to:
display that the second virtual object initiates the group joining request to the virtual building; and display, in response to a processing operation for putting the group joining request on hold, that the second virtual object steps aside to enable a next virtual object to initiate the group joining request.

In an example design of this embodiment, the virtual building corresponds to an interest tag, and the interest tag is configured for indicating at least one of a social preference of the interactive group and a behavior preference of a member in the interactive group.

The display module 810 is further configured to:
display interest information of the first virtual object, the interest information being obtained based on a third account in an interest platform indicated by the interest tag, and the third account having a binding relationship with the second account corresponding to the first virtual object.

In an example design of this embodiment, the group joining request carries application information, the application information being configured for indicating an application reason why the first virtual object requests to join the interactive group.

The display module 810 is further configured to:
display association information of the first virtual object, the association information being obtained based on a third account in an association platform indicated by the application information, and the third account having a binding relationship with the second account corresponding to the first virtual object.

In an example design of this embodiment, the apparatus further includes:
a processing module 820, configured to identify the application information to obtain an application tag of the application information.

The display module 810 is further configured to perform at least one of the following:
displaying associated identity information of the first virtual object when the application tag only indicates the association platform, the associated identity information being identity information of the third account in the association platform; or
displaying associated interaction information of the first virtual object when the application tag indicates the interaction behavior of the association platform, the associated interaction information being interaction information between the third account and a fourth account in the association platform.

The fourth account has a binding relationship with the interactive group, and/or the fourth account has a binding relationship with the first account.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

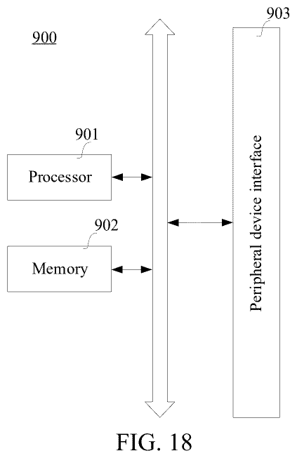

FIG. 18 is a block diagram of a structure of a computer device 900 according to an example of this application. The computer device 900 may be a portable mobile terminal, such as a smart phone, a tablet computer, a Moving Picture Experts Group Audio Layer III (MP3) player, or a Moving Picture Experts Group Audio Layer IV (MP4) player. The computer device 900 may also be referred to as another name such as user equipment or a portable terminal.

Generally, the computer device 900 includes a processor 901 and a memory 902.

Processing circuitry, such as the processor 901 may include one or more processing cores, for example, a 4-core processor or an 8-core processor. The processor 901 may be implemented in at least one hardware form among a digital signal processor (DSP), a field programmable gate array (FPGA), or a programmable logic array (PLA). The processor 901 may also include a main processor and a coprocessor. The main processor is a processor configured to process data in an awake state, and is also referred to as a central processing unit (CPU). The coprocessor is a low-power consumption processor configured to process data in a standby state. In some embodiments, the processor 901 may be integrated with a graphics processing unit (GPU). The GPU is configured to render and draw content that needs to be displayed on a display screen. In some embodiments, the processor 901 may further include an artificial intelligence (AI) processor. The AI processor is configured to process computing operations related to machine learning.

The memory 902, such as a non-transitory computer-readable storage medium, may include one or more computer-readable storage media. The computer-readable storage medium may be tangible and non-transient. The memory 902 may further include a high-speed random access memory and a nonvolatile memory, for example, one or more disk storage devices or flash storage devices. In some embodiments, the non-transitory computer-readable storage medium in the memory 902 is configured to store at least one instruction, and the at least one instruction, when executed by the processor 901, implements the method for processing a group joining request according to embodiments of this disclosure.

In some embodiments, the computer device 900 may alternatively include, for example, a peripheral device interface 903 and at least one peripheral device.

A person skilled in the art may understand that the foregoing structure does not constitute a limitation on the computer device 900, and the computer device 900 may include more components or fewer components than those shown in the figure, or some components may be combined, or a different component deployment may be used.

In an example, a chip is further provided. The chip includes a programmable logic circuit and/or program instructions. When the chip is run on a computer device, the chip is configured to implement the method for processing a group joining request according to the foregoing aspects.

In an example, a computer program product is further provided. The computer program product includes computer instructions. The computer instructions are stored in a computer-readable storage medium. A processor of a computer device reads the computer instructions from the computer-readable storage medium. The processor reads and executes the computer instructions from the computer-readable storage medium to implement the method for processing a group joining request provided in the foregoing method embodiments.

In an example, a non-transitory computer-readable storage medium is further provided. The non-transitory computer-readable storage medium has a computer program stored thereon. The computer program is loaded and executed by a processor to implement the method for processing a group joining request provided in the foregoing method embodiments.

What is claimed is:

1. A method for processing requests to join an interactive group, the method comprising:
displaying, by processing circuitry, a first virtual character and a first virtual object in a virtual environment, the first virtual object representing the interactive group, and a first user account managing the interactive group;
displaying a first request to join the interactive group, the first request to join the interactive group being initiated by the first virtual character; and
displaying, when the first request to join the interactive group is accepted, the first virtual object being entered by the first virtual character.

2. The method according to claim 1, wherein
the first request to join the interactive group is initiated when the first virtual character is reaches a request initiation region of the first virtual object.

3. The method according to claim 2, the method further comprising:
displaying a second virtual character, the second virtual character and the first virtual character being displayed in a waiting queue, the second virtual character being located behind the first virtual character in the waiting queue when the second virtual character initiates a second request to join the interactive group after the first virtual character initiates the first request to join the interactive group.

4. The method according to claim 3, the method further comprising:
displaying the second virtual character moving to a previous location of the first virtual character after the first request to join the interactive group is accepted, the previous location being a location of the first virtual object where the first virtual character initiated the first request to join the interactive group.

5. The method according to claim 2, wherein the displaying the first request to join the interactive group further comprises:
displaying the first request to join the interactive group in a form of a bubble above the first virtual character.

6. The method according to claim 5, wherein the first request to join the interactive group includes a comment from a second user account corresponding to the first virtual character.

7. The method according to claim 1, wherein after the first virtual object is entered by the first virtual character, the method further comprising:
displaying the first virtual character carrying an item corresponding to the interactive group; or
displaying the first virtual character with a group identifier of the interactive group.

8. The method according to claim 1, wherein
the first virtual character carries an item, and the item is provided to the interactive group when the first virtual character initiates the first request to join the interactive group; and
the method further comprises:
displaying the first virtual character putting the item around the first virtual object.

9. The method according to claim 1, wherein after the first virtual character enters the first virtual object, the method further comprises:
updating the display of the first virtual object, wherein a size of the first virtual object is correlated with a quantity of members in the interactive group.

10. The method according to claim 1, wherein after the first virtual character enters the first virtual object, the method further comprises:
displaying information of the first virtual character on the first virtual object.

11. The method according to claim 10, the method further comprising:
displaying a virtual identifier of the first virtual character on the first virtual object, wherein a display style of the virtual identifier is related to a quantity of members in the interactive group.

12. The method according to claim 1, the method further comprising:
displaying identity information of the first virtual character when a processing operation for viewing the identity information is performed on the displayed first request to join the interactive group, the identity information of the first virtual character including a second user account corresponding to the first virtual character.

13. The method according to claim 1, the method further comprising:
displaying a second virtual character that initiates a second request to join the interactive group; and
displaying the second virtual character moving away from the first virtual object when the second request to join the interactive group is rejected.

14. The method according to claim 1, the method further comprising:
displaying a second virtual character that initiates a second request to join the interactive group; and
displaying the second virtual character moving aside to allow a next virtual character to initiate a next request to join the interactive group when the second request to join the interactive group is on hold.

15. The method according to claim 1, wherein
the first virtual object corresponds to an interest tag, and the interest tag is configured to indicate at least one of a social preference of the interactive group and a behavior preference of a member in the interactive group; and
the method further comprises:
displaying interest information of the first virtual character, the interest information being obtained based on a third user account in an interest platform indicated by the interest tag, and the third user account having a binding relationship with a second user account corresponding to the first virtual character.

16. The method according to claim 1, wherein
the first request to join the interactive group includes a message of the first virtual character; and
the method further comprises:
displaying association information of the first virtual character, the association information being obtained based on a third user account in an association platform indicated by application information, and the third user account having a binding relationship with a second user account corresponding to the first virtual character.

17. An information processing apparatus, comprising:
processing circuitry configured to:
display a first virtual character and a first virtual object in a virtual environment, the first virtual object representing an interactive group, and a first user account managing the interactive group;
display a first request to join the interactive group, the first request to join the interactive group being initiated by the first virtual character; and
display, when the first request to join the interactive group is accepted, the first virtual object being entered by the first virtual character.

18. The information processing apparatus according to claim 17, wherein the first request to join the interactive group is initiated when the first virtual character is reaches a request initiation region of the first virtual object.

19. A non-transitory computer-readable storage medium, storing instructions which when executed by a processor cause the processor to perform:
displaying a first virtual character and a first virtual object in a virtual environment, the first virtual object representing an interactive group, and a first user account managing the interactive group;
displaying a first request to join the interactive group, the first request to join the interactive group being initiated by the first virtual character; and
displaying, when the first request to join the interactive group is accepted, the first virtual object being entered by the first virtual character.

20. The non-transitory computer-readable storage medium according to claim 19, wherein the first request to join the interactive group is initiated when the first virtual character is reaches a request initiation region of the first virtual object.
